(19) United States
(12) Patent Application Publication
(10) Pub. No.: US 2024/0406793 A1
(43) Pub. Date: Dec. 5, 2024

(54) BUFFER STATUS REPORTING FOR EXTENDED REALITY SERVICE

(71) Applicant: Lenovo (Singapore) Pte. Ltd., New Tech Park (SG)

(72) Inventors: Hossein Bagheri, Urbana, IL (US); Joachim Löhr, Wiesbaden (DE); Hyejung Jung, Northbrook, IL (US); Alexander Golitschek Edler von Elbwart, Darmstadt (DE); Vijay Nangia, Woodridge, IL (US)

(21) Appl. No.: 18/694,859

(22) PCT Filed: Sep. 22, 2022
(86) PCT No.: PCT/IB2022/058993

§ 371 Date: Mar. 22, 2024

Related U.S. Application Data
(60) Provisional application No. 63/246,796, filed on Sep. 22, 2021.

(51) Int. Cl. H04W 28/02; H04W 28/06

(52) U.S. Cl. CPC H04W 28/0278; H04W 28/06

(57) ABSTRACT

Various aspects of the present disclosure relate to buffer status reporting for extended reality service. An apparatus is configured to receive an indication of whether a first buffer status report (“BSR”) format is usable. In response to the indication indicating that the first BSR format is usable, determine a buffer size based on a first table that comprises buffer size levels corresponding to a first buffer size field. In response to the indication indicating that the first BSR format is not usable, determine the buffer size based on a second table that comprises buffer size levels corresponding to a second buffer size field, and transmit the BSR.

### CROSS REFERENCE TO RELATED APPLICATIONS

This application claims the benefit of U.S. Provisional Patent Application No. 63/246,796, entitled “BUFFER STATUS REPORTING FOR EXTENDED REALITY SERVICE” and filed on Sep. 22, 2021, for Hossein Bagheri, et al., which is incorporated herein by reference.

### FIELD

The subject matter disclosed herein relates generally to wireless communications and more particularly relates to buffer status reporting for extended reality service.

### BACKGROUND

In wireless networks, a service-oriented design considering extended reality (“XR”) traffic characteristics (e.g., variable packet arrival rate where packets arrive at 30-120 frames/second with some jitter, also packets having variable and large packet sizes) can enable more efficient (e.g., in terms of satisfying XR service requirements for a greater number of user equipment (“UEs”), or in terms of UE power saving) XR service delivery.

### BRIEF SUMMARY

Disclosed are solutions for buffer status reporting for extended reality service. The solutions may be implemented by apparatus, systems, methods, or computer program products.

In one embodiment, a first apparatus includes a transceiver and a processor coupled to the transceiver. In one embodiment, the processor is configured to cause the apparatus to receive an indication from a network that indicates whether a short format BSR with a fixed size can be used; in response to the indication indicating that a short format BSR with a fixed size can be used, determine a buffer size based on a first table that comprises buffer size levels corresponding to a first buffer size field; in response to the indication indicating that a short format BSR with a fixed size cannot be used, determine the buffer size based on a second table that comprises buffer size levels corresponding to a second buffer size field, the first buffer size field being shorter than the second buffer size field; and transmit the BSR to the network.

In one embodiment, a first method receives an indication from a network that indicates whether a short format BSR with a fixed size can be used; in response to the indication indicating that a short format BSR with a fixed size can be used, determines a buffer size based on a first table that comprises buffer size levels corresponding to a first buffer size field; in response to the indication indicating that a short format BSR with a fixed size cannot be used, determines the buffer size based on a second table that comprises buffer size levels corresponding to a second buffer size field, the first buffer size field being shorter than the second buffer size field; and transmits the BSR to the network.

In one embodiment, a second apparatus includes a transceiver and a processor coupled to the transceiver. In one embodiment, the processor is configured to cause the apparatus to transmit an indication to a UE that indicates a BSR format to be used for a BSR, the BSR format comprising one of a long format and a short format with a fixed size and receive a BSR according to the indicated BSR format, wherein in response to the indication indicating that a short format BSR with a fixed size can be used, determine a buffer size based on a first table that comprises buffer size levels corresponding to a first buffer size field, and wherein in response to the indication indicating that a short format BSR with a fixed size cannot be used, determine the buffer size based on a second table that comprises buffer size levels corresponding to a second buffer size field, the first buffer size field being shorter than the second buffer size field.

In one embodiment, a second method transmits an indication to a UE that indicates a BSR format to be used for a BSR, the BSR format comprising one of a long format and a short format with a fixed size and receive a BSR according to the indicated BSR format, wherein in response to the indication indicating that a short format BSR with a fixed size can be used, the second method determines a buffer size based on a first table that comprises buffer size levels corresponding to a first buffer size field, and wherein in response to the indication indicating that a short format BSR with a fixed size cannot be used, the second method determines the buffer size based on a second table that comprises buffer size levels corresponding to a second buffer size field, the first buffer size field being shorter than the second buffer size field.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for buffer status reporting for extended reality service;

FIG. 2 depicts a short format buffer status report (“BSR”) and a short truncated BSR medium access control-control element (“MAC CE”);

FIG. 3 depicts a long format BSR, a long truncated BSR, and a pre-emptive BSR MAC CE;

FIG. 4 depicts a recommended bit rate MAC CE;

FIG. 5 depicts one embodiment of a LogicalChannelConfig information element (“IE”);

FIG. 6 is a diagram illustrating one embodiment of a NR protocol stack;

FIG. 7 is a block diagram illustrating one embodiment of a user equipment apparatus that may be used for buffer status reporting for extended reality service;

FIG. 8 is a block diagram illustrating one embodiment of a network apparatus that may be used for buffer status reporting for extended reality service;

FIG. 9 is a flowchart diagram illustrating one embodiment of a method for buffer status reporting for extended reality service; and

FIG. 10 is a flowchart diagram illustrating one embodiment of a method for buffer status reporting for extended reality service.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for buffer status reporting for extended reality service. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

A service-oriented design considering XR traffic characteristics (e.g., variable packet arrival rate where packets arrive at 30-120 frames/second with some jitter, also packets having variable and large packet sizes) can enable more efficient (e.g., in terms of satisfying XR service requirements for a greater number of UEs, or in terms of UE power saving) XR service delivery. This disclosure, in one embodiment, describes BSR enhancements to enhance system capacity. In particular, the subject matter herein describes a buffer size indication mechanism that is enhanced to support finer buffer size granularities for the XR service to avoid resource wastage.

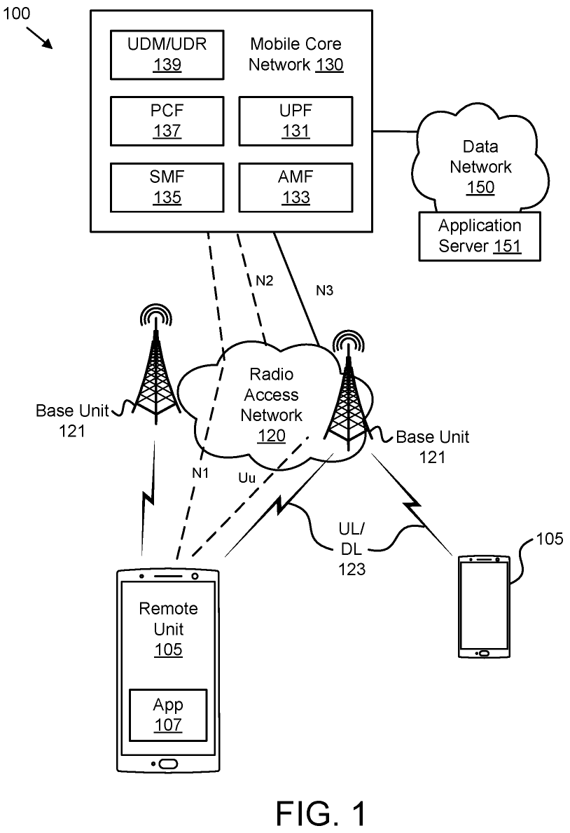

FIG. 1 depicts a wireless communication system 100 supporting buffer status reporting for extended reality service, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 130.

In some embodiments, the remote units 105 communicate with an application server via a network connection with the mobile core network 130. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as “attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”), a Policy Control Function (“PCF”) 137, a Unified Data Management function (“UDVI”) and a User Data Repository (“UDR”).

The UPF(s) 131 is responsible for packet routing and forwarding, packet inspection, QoS handling, and external PDU session for interconnecting Data Network (“DN”), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5GRAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting buffer status reporting for extended reality service.

As background, according to TS 38.321 (which is incorporated herein by reference), the BSR procedure is used to provide the serving gNB with information about UL data volume in the MAC entity. Radio resource control (“RRC”) configures the following parameters to control the BSR:
periodicBSR-Timer;
retxBSR-Timer;
logicalChannelSR-DelayTimerApplied;
logicalChannelSR-DelayTimer;
logicalChannelSR-Mask;
logicalChannelGroup.

Each logical channel may be allocated to a logical channel group (“LCG”) using the logicalChannelGroup. In one embodiment, the maximum number of LCGs is eight. The MAC entity determines the amount of UL data available for a logical channel according to a data volume calculation procedure, e.g., as in TSs 38.322 and 38.323. A BSR shall be triggered if any of the following events occur:
UL data, for a logical channel which belongs to an LCG, becomes available to the MAC entity; and either this UL data belongs to a logical channel with higher priority than the priority of any logical channel containing available UL data which belong to any LCG; or
   none of the logical channels which belong to an LCG contains any available UL data, in which case the BSR is referred below to as ‘Regular BSR’;
   UL resources are allocated and number of padding bits is equal to or larger than the size of the Buffer Status Report MAC CE plus its subheader, in which case the BSR is referred below to as ‘Padding BSR’;
retxBSR-Timer expires, and at least one of the logical channels which belong to an LCG contains UL data, in which case the BSR is referred below to as ‘Regular BSR’;
periodicBSR-Timer expires, in which case the BSR is referred below to as ‘Periodic BSR’.
NOTE 1: When Regular BSR triggering events occur for multiple logical channels simultaneously, each logical channel triggers one separate Regular BSR.

For Regular BSR, the MAC entity shall:
1> if the BSR is triggered for a logical channel for which logicalChannelSR-DelayTimerApplied with value true is configured by upper layers:
   2> start or restart the logicalChannelSR-DelayTimer.
1> else:
   2> if running, stop the logicalChannelSR-DelayTimer.

For Regular and Periodic BSR, the MAC entity shall:
1> if more than one LCG has data available for transmission when the MAC PDU containing the BSR is to be built:
   2> report Long BSR for all LCGs which have data available for transmission.
1> else:
   2> report Short BSR.

For Padding BSR, the MAC entity shall:
1> if the number of padding bits is equal to or larger than the size of the Short BSR plus its subheader but smaller than the size of the Long BSR plus its subheader:
   2> if more than one LCG has data available for transmission when the BSR is to be built:
      3> if the number of padding bits is equal to the size of the Short BSR plus its subheader:
         4> report Short Truncated BSR of the LCG with the highest priority logical channel with data available for transmission.
      3> else:
         4> report Long Truncated BSR of the LCG(s) with the logical channels having data available for transmission following a decreasing order of the highest priority logical channel (with or without data available for transmission) in each of these LCG(s), and in case of equal priority, in increasing order of LCGID.
   2> else:
      3> report Short BSR.
1> else if the number of padding bits is equal to or larger than the size of the Long BSR plus its subheader:
   2> report Long BSR for all LCGs which have data available for transmission.

For BSR triggered by retxBSR-Timer expiry, the MAC entity considers that the logical channel that triggered the BSR is the highest priority logical channel that has data available for transmission at the time the BSR is triggered.

The MAC entity shall:
1> if the Buffer Status reporting procedure determines that at least one BSR has been triggered and not cancelled:
   2> if UL-SCH resources are available for a new transmission and the UL-SCH resources can accommodate the BSR MAC CE plus its subheader as a result of logical channel prioritization:
      3> instruct the Multiplexing and Assembly procedure to generate the BSR MAC CE(s) as defined in clause 6.1.3.1;
      3> start or restart periodicBSR-Timer except when all the generated BSRs are long or short Truncated BSRs;
      3> start or restart retxBSR-Timer.
   2> if a Regular BSR has been triggered and logicalChannelSR-DelayTimer is not running:
      3> if there is no UL-SCH resource available for a new transmission; or
      3> if the MAC entity is configured with configured uplink grant(s) and the Regular BSR was triggered for a logical channel for which logicalChannelSR-Mask is set to false; or
      3> if the UL-SCH resources available for a new transmission do not meet the LCP mapping restrictions (see clause 5.4.3.1) configured for the logical channel that triggered the BSR:
         4> trigger a Scheduling Request.
NOTE 2: UL-SCH resources are considered available if the MAC entity has been configured with, receives, or determines an uplink grant. If the MAC entity has determined at a given point in time that UL-SCH resources are available, this need not imply that UL-SCH resources are available for use at that point in time.

A MAC PDU shall contain at most one BSR MAC CE, even when multiple events have triggered a BSR. The Regular BSR and the Periodic BSR shall have precedence over the padding BSR. The MAC entity shall restart retxBSR-Timer upon reception of a grant for transmission of new data on any UL-SCH.

Triggered BSRs may be cancelled when the UL grant(s) can accommodate all pending data available for transmission but is not sufficient to additionally accommodate the BSR MAC CE plus its subheader. BSRs triggered prior to MAC PDU assembly shall be cancelled when a MAC PDU is transmitted and this PDU includes a Long or Short BSR MAC CE which contains buffer status up to (and including) the last event that triggered a BSR prior to the MAC PDU assembly.
NOTE 3: MAC PDU assembly can happen at any point in time between uplink grant reception and actual transmission of the corresponding MAC PDU. BSR and SR can be triggered after the assembly of a MAC PDU which contains a BSR MAC CE, but before the transmission of this MAC PDU. In addition, BSR and SR can be triggered during MAC PDU assembly.
NOTE 4: If a HARQ process is configured with cg-RetransmissionTimer and if the BSR is already included in a MAC PDU for transmission on configured grant by this HARQ process, but not yet transmitted by lower layers, it is up to UE implementation how to handle the BSR content.

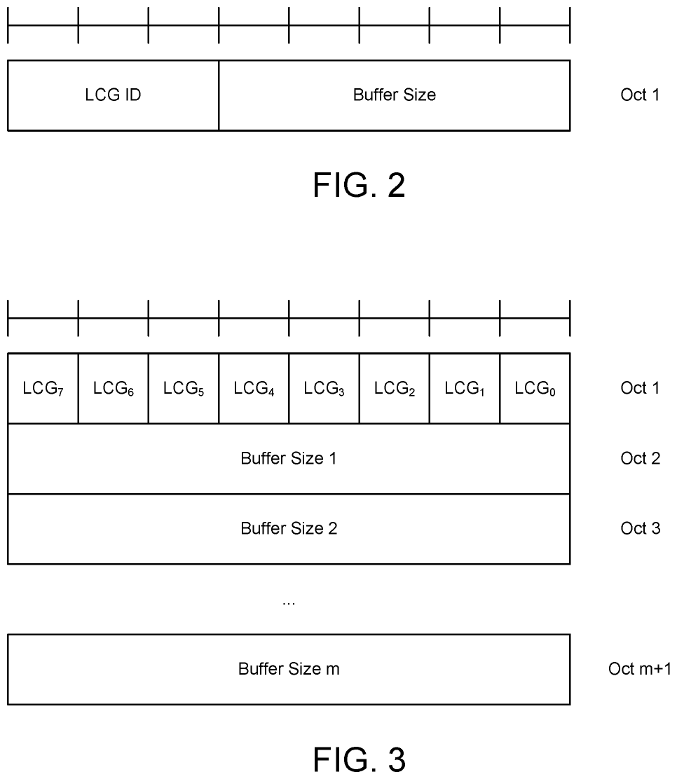

In one embodiment, the BSR MAC CE has the following fields: LCG ID, LCG, Buffer Size. Table 6.1.3.1-1 and Table 6.1.3.1-2 in TS 38.321 (incorporated herein by reference) provide buffer size levels (in bytes) for 5-bit and 8-bit Buffer Size field, respectively. The length of the buffer size field for the Short BSR format and the Short Truncated BSR format is 5 bits and for the Long BSR format and the Long Truncated BSR format is 8 bits. FIG. 2 illustrates a short BSR and short truncated BSR MAC CE, while FIG. 3 illustrates a long BSR, long truncated BSR, and pre-emptive BSR MAC CE.

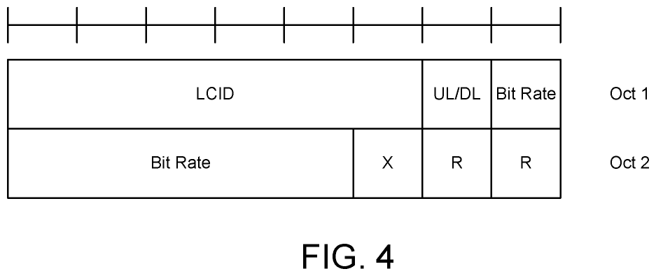

In one embodiment, the Recommended bit rate MAC CE is identified by a MAC subheader with logical channel identifier (“LCID”) as specified in Tables 6.2.1-1 and 6.2.1-2 of TS 38.321 (incorporated herein by reference) for bit rate recommendation message from the gNB to the UE and bit rate recommendation query message from the UE to the gNB, respectively. It has a fixed size and consists of two octets defined as follows (as shown in FIG. 4):
LCID: This field indicates the identity of the logical channel for which the recommended bit rate or the recommended bit rate query is applicable. The length of the field is 6 bits;
Uplink/Downlink (UL/DL): This field indicates whether the recommended bit rate or the recommended bit rate query applies to uplink or downlink. The length of the field is 1 bit. The UL/DL field set to 0 indicates downlink. The UL/DL field set to 1 indicates uplink;
Bit Rate: This field indicates an index to Table 6.1.3.20-1. The length of the field is 6 bits. For bit rate recommendation the value indicates the recommended bit rate. For bit rate recommendation query the value indicates the desired bit rate;
X: Bit rate multiplier. For UEs supporting recommended bit rate multiplier, when bitRateMultiplier is configured for the logical channel indicated by LCID field, X field set to “1” indicates the actual value of bit rate is the value corresponding to the index indicated by the Bit Rate field multiplied by bitRateMultiplier as specified in TS 38.331.
R: reserved bit, set to 0.

TABLE 6.1.3.20-1
Values (kbit/s) for Bit Rate field

| | NR | | NR |
|---|---|---|---|
| | Recommended | | Recommended |
| | Bit Rate value | | Bit Rate value |
| Index | [kbit/s] | Index | [kbit/s |
| 0 | Note 1 | 32 | 700 |
| 1 | 0 | 33 | 800 |
| 2 | 9 | 34 | 900 |
| 3 | 11 | 35 | 1000 |
| 4 | 13 | 36 | 1100 |
| 5 | 17 | 37 | 1200 |
| 6 | 21 | 38 | 1300 |
| 7 | 25 | 39 | 1400 |
| 8 | 29 | 40 | 1500 |
| 9 | 32 | 41 | 1750 |
| 10 | 36 | 42 | 2000 |
| 11 | 40 | 43 | 2250 |
| 12 | 48 | 44 | 2500 |
| 13 | 56 | 45 | 2750 |
| 14 | 72 | 46 | 3000 |
| 15 | 88 | 47 | 3500 |
| 16 | 104 | 48 | 4000 |
| 17 | 120 | 49 | 4500 |
| 18 | 140 | 50 | 5000 |
| 19 | 160 | 51 | 5500 |
| 20 | 180 | 52 | 6000 |
| 21 | 200 | 53 | 6500 |
| 22 | 220 | 54 | 7000 |
| 23 | 240 | 55 | 7500 |
| 24 | 260 | 56 | 8000 |
| 25 | 280 | 57 | Reserved |
| 26 | 300 | 58 | Reserved |
| 27 | 350 | 59 | Reserved |
| 28 | 400 | 60 | Reserved |
| 29 | 450 | 61 | Reserved |
| 30 | 500 | 62 | Reserved |
| 31 | 600 | 63 | Reserved |

Note 1:
For bit rate recommendation message this index is used for indicating that no new recommendation on bit rate is given.

In one embodiment, eXtended Reality (“XR”) and Cloud Gaming (“CG”) important 5G media applications under consideration in the industry. According to TR 26.928, XR is an umbrella term for different types of realities including:
Virtual reality (“VR”) is a rendered version of a delivered visual and audio scene. The rendering is designed to mimic the visual and audio sensory stimuli of the real world as naturally as possible to an observer or user as they move within the limits defined by the application. Virtual reality usually, but not necessarily, requires a user to wear a head mounted display (“HMD”), to completely replace the user's field of view with a simulated visual component, and to wear headphones, to provide the user with the accompanying audio. Some form of head and motion tracking of the user in VR is usually also necessary to allow the simulated visual and audio components to be updated in order to ensure that, from the user's perspective, items and sound sources remain consistent with the user's movements. Additional means to interact with the virtual reality simulation may be provided but are not strictly necessary.
Augmented reality (“AR”) is when a user is provided with additional information or artificially generated items or content overlaid upon their current environment. Such additional information or content will usually be visual and/or audible and their observation of their current environment may be direct, with no intermediate sensing, processing and rendering, or indirect, where their perception of their environment is relayed via sensors and may be enhanced or processed.
Mixed reality (“MR”) is an advanced form of AR where some virtual elements are inserted into the physical scene with the intent to provide the illusion that these elements are part of the real scene.
Extended reality (“XR”) refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. A key aspect of XR is the extension of human experiences especially relating to the senses of existence (represented by VR) and the acquisition of cognition (represented by AR).

In the following described solutions, instead of “slot,” “mini-slot,” “subslot,” or “aggregated slots” can also be used, wherein the notion of slot/mini-slot/sub-slot/aggregated slots can be described as defined in TS 38.211/TS 38.213/TS 38.214 (which are incorporated herein by reference).

Throughout this disclosure reference to TS 38.211, TS 38.212, TS 38.213, TS 38.214, is associated to current version of the specifications V16.6.0, and TS 38.321 is associated with the current version of the specifications V16.5.0.

Several embodiments are described below. According to a possible embodiment, one or more elements or features from one or more of the described embodiments may be combined.

Considering UL AR traffic (e.g., a stream aggregating streams of scene, video, data, and audio) with 60 fps, and 10 Mbps data rate, each frame/packet is about 20834 bytes on average. Considering packet size variation (e.g., according to a truncated gaussian distribution with [STD, Max, Min]: [10.5, 150, 50]% of Mean packet size), buffer size levels in BSR MAC-CE might not be accurate enough. For instance, for 20834 bytes, BS (Buffer Size) index 25 in 5-bit BSR table, e.g., short BSR, is used/indicated, where that BS index 25 can support up to 28581 bytes (BS value corresponding to index 24 is <=20516 bytes), the difference between the actual and maximum buffer size could be about 27% (gNB needs to allocate about 27% more resources). Considering low packet error rate requirements for XR (e.g., 1%), such a difference in allocated resources, might lead to inefficient resource allocation. In the following, we propose various solutions to enhance buffer size indication.

In one embodiment, a UE is configured with a first table containing (e.g., a first set of) buffer size levels (in bytes) with ‘k’ number of bits for the buffer size field of BSR MAC-CE (e.g., ‘k=5’) and the UE determines a second table containing (e.g., a second set of) buffer size levels with ‘k’ number of bits for the buffer size field of BSR MAC-CE (e.g., ‘k=5’).

In such an embodiment, the UE uses the first table for a first set of LCGs, and the second table for a second set of LCGs, the set can include one LCG wherein at least one buffer size level is different between the two tables. In one embodiment, the second table could have buffer level sizes spaced closer to each other for a range of buffer sizes (e.g., −3*STD+m to 3*STD+m considering STD being around e.g., 10.5% of the mean packet size (m) for AR traffic; in another example, in the range of buffer sizes (Min % of Mean packet size, Max % of Mean packet size)), wherein ‘Min %’, and ‘Max %’ are percentages.

In another embodiment, the UE is configured with a first Buffer size level table associated with at least a first LCG, and a second Buffer size level table associated with at least a second LCG, wherein at least one buffer size level is different between the two tables. The UE uses the first Buffer size level table to report the Buffer size associated with at least the first LCG in a BSR 5 when the first logical channel group has data available and uses the second Buffer size level table to report the Buffer size associated with at least the second LCG in a BSR when the second logical channel group has data available.

In one embodiment, the second table is configured for the LE. For short BSR, the LE is configured with using the 8-bit buffer size table (Table 6.1.3.1-2 in TS 38.321) or a subset of values from the 8-bit buffer size table as the second table for a set of LCGs. An example of the 5-bit second table for short BSR is provided in table 1 below (with changes italicized and bolded, and new values are taken from the 8-bit Buffer size table in TS 38.321).

TABLE 1
existing Buffer size levels (in bytes) for 5-bit Buffer Size field

| Index | BS value |
|---|---|
| 0 | 0 |
| 1 | ≤10 |
| 2 | ≤14 |
| 3 | ≤20 |
| 4 | ≤28 |
| 5 | ≤38 |
| 6 | ≤53 |
| 7 | ≤74 |
| 8 | ≤102 |
| 9 | ≤142 |
| 10 | ≤198 |
| 11 | ≤276 |
| 12 | ≤384 |
| 13 | ≤535 |
| 14 | ≤745 |
| 15 | ≤1038 |
| 16 | ≤1446 |
| 17 | ≤2014 |
| 18 | ≤2806 |
| 19 | ≤3909 |
| 20 | ≤5446 |
| 21 | ≤7587 |
| 22 | ≤10570 |
| 23 | ≤14726 |
| 24 | ≤20516 |
| 25 | ≤28581 |
| 26 | ≤39818 |
| 27 | ≤55474 |
| 28 | ≤77284 |
| 29 | ≤107669 |
| 30 | ≤150000 |
| 31 | >150000 |

TABLE 2
new Buffer size levels (in bytes) for 5-bit Buffer Size field

| Index | BS value | Index | BS value | Index | BS value | Index | BS value | Index | BS value |
|---|---|---|---|---|---|---|---|---|---|
| 0 | 0 | 3 | ≤102 | 11 | ≤1446 | 19 | ≤17795 | [symbol] | [symbol] |
| 1 | ≤10 | 4 | ≤142 | 12 | ≤2014 | 20 | ≤20516 | [symbol] | [symbol] |
| [symbol] | [symbol] | 5 | ≤198 | 13 | ≤2806 | 21 | ≤22885 | 26 | ≤39818 |
| [symbol] | [symbol] | 6 | ≤276 | 14 | ≤3909 | 22 | ≤25953 | 27 | ≤55474 |
| [symbol] | [symbol] | 7 | ≤384 | 15 | ≤5446 | 23 | ≤28581 | 28 | ≤77284 |
| [symbol] | [symbol] | 8 | ≤535 | 16 | ≤7587 | 24 | ≤31342 | 29 | ≤107669 |
| [symbol] | [symbol] | 9 | ≤745 | 17 | ≤10570 | 25 | ≤33376 | 30 | ≤150000 |
| 2 | ≤74 | 10 | ≤1038 | 18 | ≤14726 | [symbol] | [symbol] | 31 | >150000 |

In one embodiment, the second table is derived based on some traffic parameters. The traffic parameters include traffic packet statistics such as mean packet size and STD, fps, or the like. Traffic parameters (such as mean packet size, mean packet jitter, etc.) could be indicated in the BSR or could be tied to LCG ID.

In one embodiment, the second table is the first table for short format BSR, the UE is configured with the 8-bit buffer size table (Table 6.1.3.1-2 in TS 38.321) for all LCGs.

In one embodiment, the UE uses the second table (based on the 8-bit buffer size table (Table 6.1.3.1-2 in TS 38.321)) for a certain time duration (e.g., determined by a timer expiry) from being scheduled with a particular traffic (e.g., XR traffic including scene and/or video for UL).

In one embodiment, the UE uses the second table (based on the 8-bit buffer size table (Table 6.1.3.1-2 in TS 38.321)) upon reception of a MAC CE/downlink control information (“DCI”) indication. The MAC CE/DCI indication could indicate activation/start of potential XR traffic. The DCI indication could be a DCI activating configured grant transmissions with a particular periodicity (e.g., 4 ms).

In one embodiment, the UE indicates which table is used for buffer size indication (e.g., per LCG).

In one embodiment, the UE indicates a set of parameters (e.g., mean packet size associated with the LCG) with which gNB could determine the buffer size level based on the indicated index and the set of parameters.

In one embodiment, the network configures the UE on whether to use a default first table (5-bit short BS field Table 6.1.3.1-1 in TS 38.321) or a second table for an LCG.

In one embodiment, the network may configure the UE with the buffer size levels for the second table. For example, based on a bitmap (“Bi”) of a potential set of buffer size values (e.g., bit field Bi corresponds to buffer size level BSi) with a Bi field is set to ‘1’ to indicate that the buffer size level BSi is present and mapped to a codepoint of the Buffer Size field. The Bi field is set to ‘0’ to indicate that the buffer size level BSi is not present and is not mapped to a codepoint of the Buffer Size field. The codepoint to which the Buffer Size level is mapped is determined by its ordinal position among all the Buffer Size levels with Bi field set to 1, i.e. the first Buffer Size level with Bi field set to 1 shall be mapped to the codepoint value 0, second Buffer Size level with Bi field set to 1 shall be mapped to the codepoint value 1 and so on. The maximum number of Buffer Size levels for short BSR is 32.

In one embodiment, an LCG is assigned to a set of XR related traffic (e.g., AR traffic).

In one embodiment, two LCG types can be defined. One LCG type can belong to XR related traffic, and the other LCG type can cover the rest of the possible traffic. One LCG type can be associated with I frames and one LCG type can be associated with P frames.

In one embodiment, for Regular BSR, the MAC entity shall:
1> if more than one LCG has data available for transmission when the MAC PDU containing the BSR is to be built:
   2> report a first type of Long BSR for all LCGs of the first type which have data available for transmission.
   2> report a second type of Long BSR for all LCGs of the second type which have data available for transmission.
1> else:
   2> report Short BSR.

Wherein the first and the second LCG types can use different or same tables for buffer size. In one embodiment, separating resources may be needed for high/medium reliability from resources needed for low/regular priority. Also, different traffic might have different packet delay bound (“PDB”), so gNB that has application awareness capability (knowledge of some traffic aspects such as reliability/delay requirement) could benefit from having different (long) BSRs.

In one embodiment, for Regular BSR, the MAC entity shall, if more than one LCG has data available for transmission when the MAC PDU containing the BSR is to be built, report Long BSR for all LCGs which have data available for transmission. The UE indicates which LCG has most of the data (or more than ‘x’%) to be sent (e.g., in the BSR MAC-CE), so gNB can use traffic parameters/characteristics of the LCG with most data to assign resources efficiently.

If short BSR uses 8-bit Buffer Size field table, padding bits are added to the short BSR to make it 16 bits instead of 8 bits. A field in the MAC subheader of the short MAC CE may indicate if the short BSR is an 8-bit MAC CE or a 16-bit MAC CE. In one example, the one-bit may be a reserved bit in the MAC subheader. In another alternative, a new reserved LCID may indicate a 16-bit short BSR MAC CE.

In one embodiment, the UE is configured to report long BSR or long truncated BSR MAC CE for cases where the UE reports the buffer status of a preconfigured LCG, e.g., LCG that is used for XR related traffic. Even for cases where the buffer status is reported for single LCG, the UE reports long BSR or truncated long BSR MAC CE. In one implementation, a field in the MAC subheader or the MAC CE may indicate that the UE has no data available for transmission for other LCGs.

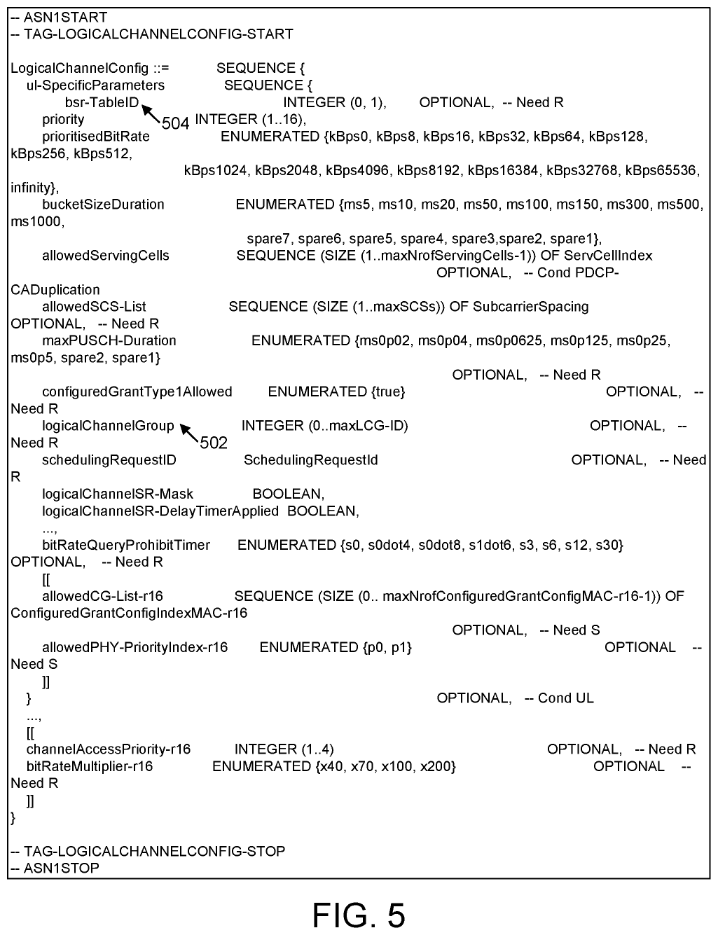

In one implementation, a plurality of tables, each table specifying a set of buffer size levels (e.g. in bytes) for a given X-bit (e.g. X=5 or 8) Buffer Size field, are predefined or configured for a UE. The UE, in one embodiment, receives information or an indication of a buffer size level table (equivalently, a set of buffer size levels) associated with a logical channel in a logical channel configuration, as shown in FIG. 5. The UE does not expect that logical channels with the same logical channel group identity are configured with different buffer size level tables (e.g., different sets of buffer size levels). The UE uses the indicated buffer size level table to send a buffer status report for the logical channel.

In one embodiment, the LogicalChannelConfig IE depicted in FIG. 5 is used to configure the logical channel parameters. In one embodiment, the logicalChannelGroup parameter 502 is an ID of the logical channel group, as specified in TS 38.321, which the logical channel belongs to. In one embodiment, the bsr-TableID parameter 504 is an ID of the buffer size level table to be used for a buffer status report for the logical channel. The UE does not expect that logical channels with the same logical channel group ID are configured with different bsr-TableID values. If not configured, the UE uses a default buffer size level table for a given X-bit (X=5 or 8) Buffer Size field.

In one example, the logical channel configuration includes a parameter regarding the traffic nature of the UL data associated with the LCG, such as a field indicating whether group of pictures (“GOP”)-based or slice-based (e.g., as used in H.264 Advanced Video Coding) video encoding is used for the traffic associated with the LCG. The field could have a field value indicating other types of traffic (e.g., such as web browsing, etc.).

In one embodiment directed to mechanisms to provide more accurate recommended bit rate MAC CE, new values (e.g., other than the values already provided in bitRateMultiplier-r16 RRC parameter, i.e., 40, 70, 100, 200}) for the bitRateMultiplier can be used to enhance the granularity of the recommended bit rate. In an example, an offset is configured (e.g., −2), and the bitrate multiplier will be determined based on the RRC indicated bitRateMultiplier, and the offset. In another example, the offset/new value of the bitrate multiplier is only applicable to a certain range of the values (e.g., values in the range of 2000 to 4000) in the Bit Rate field (e.g., Table 6.1.3.20-1 in TS 38.321) used for determining the recommended bit rate.

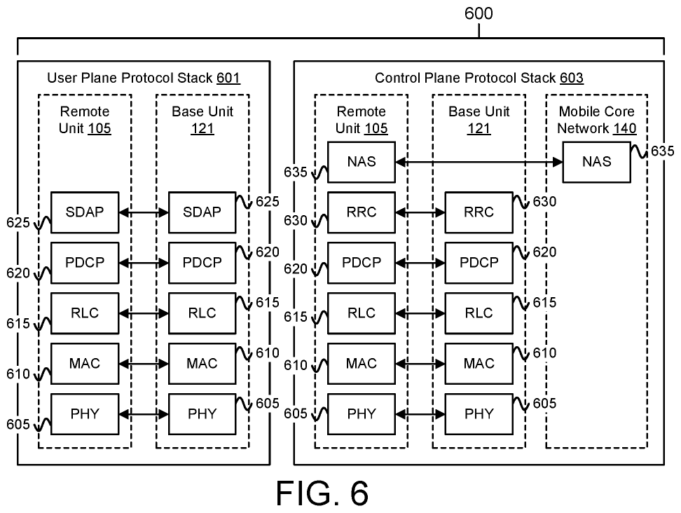

FIG. 6 depicts a NR protocol stack 600, according to embodiments of the disclosure. While FIG. 6 shows the remote unit 105, the base unit 121 and the mobile core network 130, these are representative of a set of UEs interacting with a RAN node and a NF (e.g., AMF) in a core network. As depicted, the protocol stack 600 comprises a User Plane protocol stack 601 and a Control Plane protocol stack 603. The User Plane protocol stack 604 includes a physical (“PHY”) layer 605, a MAC sublayer 610, a Radio Link Control (“RLC”) sublayer 615, a Packet Data Convergence Protocol (“PDCP”) sublayer 620, and Service Data Adaptation Protocol (“SDAP”) layer 625. The Control Plane protocol stack 603 also includes a physical layer 605, a MAC sublayer 610, a RLC sublayer 615, and a PDCP sublayer 620. The Control Place protocol stack 603 also includes an RRC sublayer and a Non-Access Stratum (“NAS”) layer 635.

The AS protocol stack for the Control Plane protocol stack 603 consists of at least RRC, PDCP, RLC and MAC sublayers, and the physical layer. The AS protocol stack for the User Plane protocol stack 601 consists of at least SDAP, PDCP, RLC and MAC sublayers, and the physical layer. The Layer-2 (“L2”) is split into the SDAP, PDCP, RLC and MAC sublayers. The Layer-3 (“L3”) includes the RRC sublayer 630 and the NAS layer 635 for the control plane and includes, e.g., an Internet Protocol (“IP”) layer or PDU Layer (note depicted) for the user plane. L1 and L2 are referred to as “lower layers” such as PUCCH/PUSCH or MAC CE, while L3 and above (e.g., transport layer, application layer) are referred to as “higher layers” or “upper layers” such as RRC.

The physical layer 605 offers transport channels to the MAC sublayer 610. The MAC sublayer 610 offers logical channels to the RLC sublayer 615. The RLC sublayer 615 offers RLC channels to the PDCP sublayer 620. The PDCP sublayer 620 offers radio bearers to the SDAP sublayer 625 and/or RRC layer 630. The SDAP sublayer 625 offers QoS flows to the mobile core network 130 (e.g., 5GC). The RRC layer 630 provides for the addition, modification, and release of Carrier Aggregation and/or Dual Connectivity. The RRC layer 630 also manages the establishment, configuration, maintenance, and release of Signaling Radio Bearers (“SRBs”) and Data Radio Bearers (“DRBs”). In certain embodiments, a RRC entity functions for detection of and recovery from radio link failure.

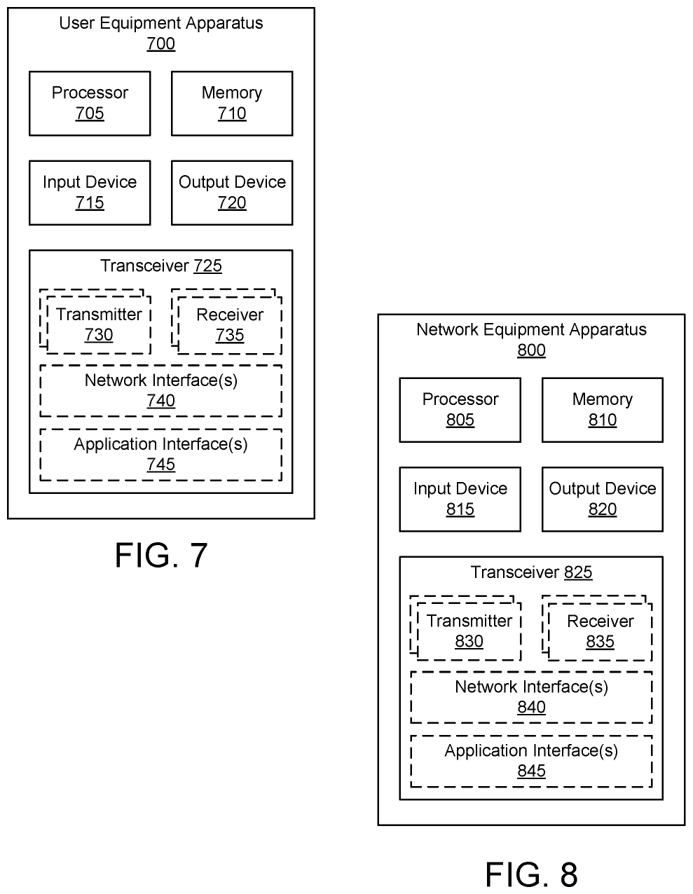

FIG. 7 depicts a user equipment apparatus 700 that may be used for buffer status reporting for extended reality service, according to embodiments of the disclosure. In various embodiments, the user equipment apparatus 700 is used to implement one or more of the solutions described above. The user equipment apparatus 700 may be one embodiment of a UE, such as the remote unit 105 and/or the UE 205, as described above. Furthermore, the user equipment apparatus 700 may include a processor 705, a memory 710, an input device 715, an output device 720, and a transceiver 725. In some embodiments, the input device 715 and the output device 720 are combined into a single device, such as a touchscreen. In certain embodiments, the user equipment apparatus 700 may not include any input device 715 and/or output device 720. In various embodiments, the user equipment apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. Here, the transceiver 725 communicates with one or more base units 121. Additionally, the transceiver 725 may support at least one network interface 740 and/or application interface 745. The application interface(s) 745 may support one or more APIs. The network interface(s) 740 may support 3GPP reference points, such as Uu and PC5. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725. In certain embodiments, the processor 705 may include an application processor (also known as “main processor”) which manages application-domain and operating system (“OS”) functions and a baseband processor (also known as “baseband radio processor”) which manages radio functions.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to buffer status reporting for extended reality service. For example, the memory 710 may store parameters, configurations, resource assignments, policies, and the like as described above. In certain embodiments, the memory 710 also stores program code and related data, such as an operating system or other controller algorithms operating on the user equipment apparatus 700, and one or more software applications.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display separate from, but communicatively coupled to, the rest of the user equipment apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 includes at least transmitter 730 and at least one receiver 735. The transceiver 725 may be used to provide UL communication signals to a base unit 121 and to receive DL communication signals from the base unit 121, as described herein. Similarly, the transceiver 725 may be used to transmit and receive SL signals (e.g., V2X communication), as described herein. Although only one transmitter 730 and one receiver 735 are illustrated, the user equipment apparatus 700 may have any suitable number of transmitters 730 and receivers 735. Further, the transmitter(s) 730 and the receiver(s) 735 may be any suitable type of transmitters and receivers. In one embodiment, the transceiver 725 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 725, transmitters 730, and receivers 735 may be implemented as physically separate components that access a shared hardware resource and/or software resource, such as for example, the network interface 740.

In various embodiments, one or more transmitters 730 and/or one or more receivers 735 may be implemented and/or integrated into a single hardware component, such as a multi-transceiver chip, a system-on-a-chip, an ASIC, or other type of hardware component. In certain embodiments, one or more transmitters 730 and/or one or more receivers 735 may be implemented and/or integrated into a multi-chip module. In some embodiments, other components such as the network interface 740 or other hardware components/circuits may be integrated with any number of transmitters 730 and/or receivers 735 into a single chip. In such embodiment, the transmitters 730 and receivers 735 may be logically configured as a transceiver 725 that uses one more common control signals or as modular transmitters 730 and receivers 735 implemented in the same hardware chip or in a multi-chip module.

In one embodiment, the processor 705 receives an indication from a network that indicates whether a short format BSR with a fixed size can be used; in response to the indication indicating that a short format BSR with a fixed size can be used, determine a buffer size based on a first table that comprises buffer size levels corresponding to a first buffer size field; in response to the indication indicating that a short format BSR with a fixed size cannot be used, determine the buffer size based on a second table that comprises buffer size levels corresponding to a second buffer size field, the first buffer size field being shorter than the second buffer size field; and transmit the BSR to the network.

In one embodiment, the first buffer size field, the second buffer size field, or both, identifies a total amount of data available according to a data volume calculation procedure across logical channels of a logical channel group after a medium access control packet data unit has been built.

In one embodiment, the indication is a radio resource control indication.

In one embodiment, the indication is a medium access control-control element indication or a downlink control information indication and wherein the indication is applicable for certain time duration or until a timer expires.

In one embodiment, the first table comprises 5-bit buffer size levels and the second table comprises 8-bit buffer size levels.

In one embodiment, the indication further comprises a logical channel group identifier, the indication indicating whether the short format BSR with the fixed size can be used for the logical channel group identifier.

In one embodiment, the indication indicates that the short format BSR with the fixed size can be used for a first logical channel group identifier and that the short format BSR with the fixed size cannot be used for a second logical channel group identifier.

In one embodiment, the processor 705 is configured to determine a first logical channel identifier that corresponds to a BSR with the short format associated with the first logical channel group identifier and a second logical channel identifier that corresponds to a BSR with a long format associated with the second logical channel group identifier and prepare at least one of the BSR with the short format and the BSR with the long format.

In one embodiment, the processor 705 is configured to determine whether a BSR is triggered, determine logical channel groups to be included in the BSR, determine a BSR format for the triggered BSR according to the indication and the determined logical channel groups, and transmit the BSR according to the determined BSR format.

In one embodiment, at least one of the first table and the second table is indicated for a logical channel in a corresponding logical channel configuration.

In one embodiment, logical channels of a logical channel group at least have the same first table, the same second table, or both.

In one embodiment, the processor 705 is configured to report a long format BSR based on the second table for logical channel groups that have data available for transmission in response to more than one logical channel group having data available for transmission when the medium access control packet data unit containing the BSR is built.

FIG. 8 depicts one embodiment of a network apparatus 800 that may be used for buffer status reporting for extended reality service, according to embodiments of the disclosure. In some embodiments, the network apparatus 800 may be one embodiment of a RAN node and its supporting hardware, such as the base unit 121 and/or gNB, described above. Furthermore, network apparatus 800 may include a processor 805, a memory 810, an input device 815, an output device 820, and a transceiver 825. In certain embodiments, the network apparatus 800 does not include any input device 815 and/or output device 820.

As depicted, the transceiver 825 includes at least one transmitter 830 and at least one receiver 835. Here, the transceiver 825 communicates with one or more remote units 105. Additionally, the transceiver 825 may support at least one network interface 840 and/or application interface 845. The application interface(s) 845 may support one or more APIs. The network interface(s) 840 may support 3GPP reference points, such as Uu, N1, N2, N3, N5, N6 and/or N7 interfaces. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a CPU, a GPU, an auxiliary processing unit, an FPGA, a DSP, a co-processor, an application-specific processor, or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825. In certain embodiments, the processor 805 may include an application processor (also known as “main processor”) which manages application-domain and OS functions and a baseband processor (also known as “baseband radio processor”) which manages radio function. In various embodiments, the processor 805 controls the network apparatus 800 to implement the above described network entity behaviors (e.g., of the gNB) for buffer status reporting for extended reality service.

The memory 810, in one embodiment, is a computer readable storage medium. In some embodiments, the memory 810 includes volatile computer storage media. For example, the memory 810 may include a RAM, including DRAM, SDRAM, and/or SRAM. In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data relating to buffer status reporting for extended reality service. For example, the memory 810 may store parameters, configurations, resource assignments, policies, and the like as described above. In certain embodiments, the memory 810 also stores program code and related data, such as an OS or other controller algorithms operating on the network apparatus 800, and one or more software applications.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, may include any known electronically controllable display or display device. The output device 820 may be designed to output visual, audible, and/or haptic signals. In some embodiments, the output device 820 includes an electronic display capable of outputting visual data to a user. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all or portions of the output device 820 may be integrated with the input device 815. For example, the input device 815 and output device 820 may form a touchscreen or similar touch-sensitive display. In other embodiments, all or portions of the output device 820 may be located near the input device 815.

As discussed above, the transceiver 825 may communicate with one or more remote units and/or with one or more interworking functions that provide access to one or more PLMNs. The transceiver 825 may also communicate with one or more network functions (e.g., in the mobile core network 80). The transceiver 825 operates under the control of the processor 805 to transmit messages, data, and other signals and also to receive messages, data, and other signals. For example, the processor 805 may selectively activate the transceiver (or portions thereof) at particular times in order to send and receive messages.

The transceiver 825 may include one or more transmitters 830 and one or more receivers 835. In certain embodiments, the one or more transmitters 830 and/or the one or more receivers 835 may share transceiver hardware and/or circuitry. For example, the one or more transmitters 830 and/or the one or more receivers 835 may share antenna(s), antenna tuner(s), amplifier(s), filter(s), oscillator(s), mixer(s), modulator/demodulator(s), power supply, and the like. In one embodiment, the transceiver 825 implements multiple logical transceivers using different communication protocols or protocol stacks, while using common physical hardware.

In one embodiment, the processor 905 is configured transmit an indication to a UE that indicates a BSR format to be used for a BSR, the BSR format comprising one of a long format and a short format with a fixed size and receive a BSR according to the indicated BSR format, wherein in response to the indication indicating that a short format BSR with a fixed size can be used, determine a buffer size based on a first table that comprises buffer size levels corresponding to a first buffer size field, and wherein in response to the indication indicating that a short format BSR with a fixed size cannot be used, determine the buffer size based on a second table that comprises buffer size levels corresponding to a second buffer size field, the first buffer size field being shorter than the second buffer size field.

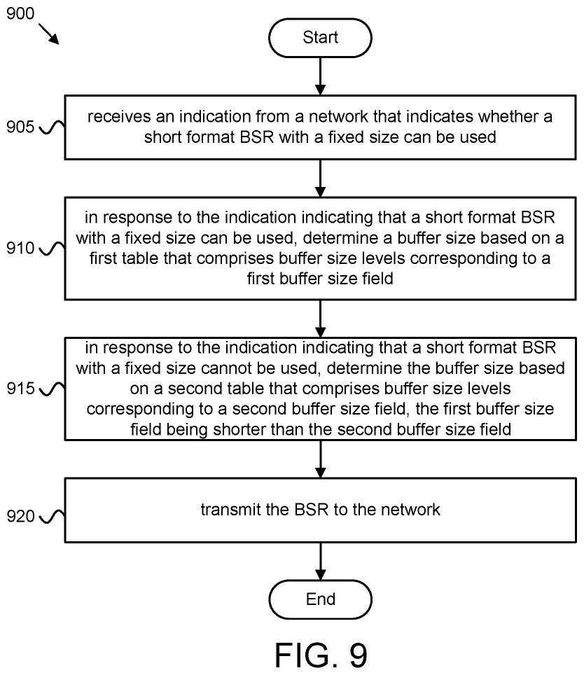

FIG. 9 is a flowchart diagram of a method 900 for buffer status reporting for extended reality service. The method 900 may be performed by a UE apparatus as described herein, for example, remote unit 105 and/or the user equipment apparatus 700. In some embodiments, the method 900 may be performed by a processor executing program code, for example, a microcontroller, a microprocessor, a CPU, a GPU, an auxiliary processing unit, a FPGA, or the like.

In one embodiment, the method 900 begins and receives 905 an indication from a network that indicates whether a short format BSR with a fixed size can be used. In one embodiment, the method 900, in response to the indication indicating that a short format BSR with a fixed size can be used, determines 910 a buffer size based on a first table that comprises buffer size levels corresponding to a first buffer size field. In one embodiment, the method 900, in response to the indication indicating that a short format BSR with a fixed size cannot be used, determines 915 the buffer size based on a second table that comprises buffer size levels corresponding to a second buffer size field, the first buffer size field being shorter than the second buffer size field. In one embodiment, the method 900 transmits 920 the BSR to the network, and the method 900 ends.

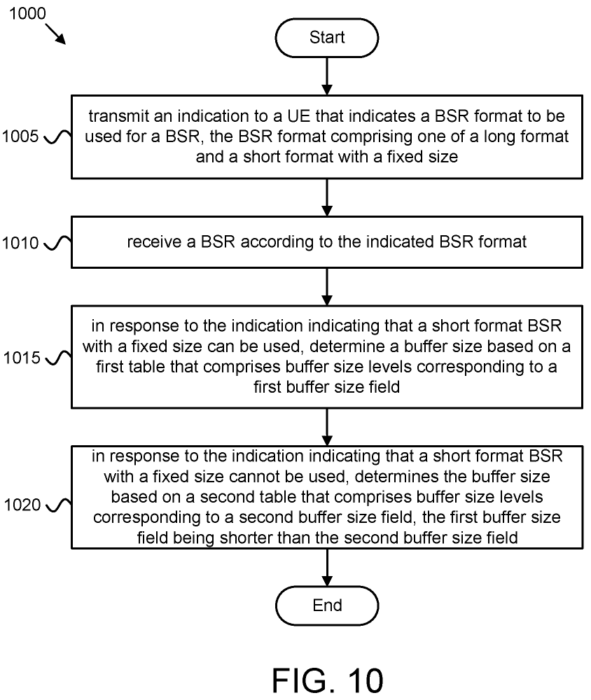

FIG. 10 is a flowchart diagram of a method 1000 for buffer status reporting for extended reality service. The method 1000 may be performed by a network apparatus as described herein, for example, the gNB, base station 121, and/or the network equipment apparatus 800. In some embodiments, the method 1000 may be performed by a processor executing program code, for example, a microcontroller, a microprocessor, a CPU, a GPU, an auxiliary processing unit, a FPGA, or the like.

The method 1000, in one embodiment, begins and transmits 1005 an indication to a UE that indicates a BSR format to be used for a BSR, the BSR format comprising one of a long format and a short format with a fixed size. In one embodiment, the method 1000 receives 1010 a BSR according to the indicated BSR format. In one embodiment, the method 1000, in response to the indication indicating that a short format BSR with a fixed size can be used, determines 1015 a buffer size based on a first table that comprises buffer size levels corresponding to a first buffer size field. In one embodiment, the method 1000, in response to the indication indicating that a short format BSR with a fixed size cannot be used, determines 1020 the buffer size based on a second table that comprises buffer size levels corresponding to a second buffer size field, the first buffer size field being shorter than the second buffer size field, and the method 1000 ends.

A first apparatus is disclosed for buffer status reporting for extended reality service. The first apparatus may include a UE apparatus as described herein, for example, remote unit 105 and/or the user equipment apparatus 700. In some embodiments, the first apparatus may include a processor executing program code, for example, a microcontroller, a microprocessor, a CPU, a GPU, an auxiliary processing unit, a FPGA, or the like.

In one embodiment, the first apparatus includes a transceiver and a processor coupled to the transceiver. In one embodiment, the processor is configured to cause the apparatus to receive an indication from a network that indicates whether a short format BSR with a fixed size can be used; in response to the indication indicating that a short format BSR with a fixed size can be used, determine a buffer size based on a first table that comprises buffer size levels corresponding to a first buffer size field; in response to the indication indicating that a short format BSR with a fixed size cannot be used, determine the buffer size based on a second table that comprises buffer size levels corresponding to a second buffer size field, the first buffer size field being shorter than the second buffer size field; and transmit the BSR to the network.

In one embodiment, the first buffer size field, the second buffer size field, or both, identifies a total amount of data available according to a data volume calculation procedure across logical channels of a logical channel group after a medium access control packet data unit has been built.

In one embodiment, the indication is a radio resource control indication.

In one embodiment, the indication is a medium access control-control element indication or a downlink control information indication and wherein the indication is applicable for certain time duration or until a timer expires.

In one embodiment, the first table comprises 5-bit buffer size levels and the second table comprises 8-bit buffer size levels.

In one embodiment, the indication further comprises a logical channel group identifier, the indication indicating whether the short format BSR with the fixed size can be used for the logical channel group identifier.

In one embodiment, the indication indicates that the short format BSR with the fixed size can be used for a first logical channel group identifier and that the short format BSR with the fixed size cannot be used for a second logical channel group identifier.

In one embodiment, the processor is configured to cause the apparatus to determine a first logical channel identifier that corresponds to a BSR with the short format associated with the first logical channel group identifier and a second logical channel identifier that corresponds to a BSR with a long format associated with the second logical channel group identifier and prepare at least one of the BSR with the short format and the BSR with the long format.

In one embodiment, the processor is configured to cause the apparatus to determine whether a BSR is triggered, determine logical channel groups to be included in the BSR, determine a BSR format for the triggered BSR according to the indication and the determined logical channel groups, and transmit the BSR according to the determined BSR format.

In one embodiment, at least one of the first table and the second table is indicated for a logical channel in a corresponding logical channel configuration.

In one embodiment, logical channels of a logical channel group at least have the same first table, the same second table, or both.

In one embodiment, the processor is configured to cause the apparatus to report a long format BSR based on the second table for logical channel groups that have data available for transmission in response to more than one logical channel group having data available for transmission when the medium access control packet data unit containing the BSR is built.

A first method is disclosed for buffer status reporting for extended reality service. The first method may be performed by a UE apparatus as described herein, for example, remote unit 105 and/or the user equipment apparatus 700. In some embodiments, the first method may be performed by a processor executing program code, for example, a microcontroller, a microprocessor, a CPU, a GPU, an auxiliary processing unit, a FPGA, or the like.

In one embodiment, the first method receives an indication from a network that indicates whether a short format BSR with a fixed size can be used; in response to the indication indicating that a short format BSR with a fixed size can be used, determines a buffer size based on a first table that comprises buffer size levels corresponding to a first buffer size field; in response to the indication indicating that a short format BSR with a fixed size cannot be used, determines the buffer size based on a second table that comprises buffer size levels corresponding to a second buffer size field, the first buffer size field being shorter than the second buffer size field; and transmits the BSR to the network.

In one embodiment, the first buffer size field, the second buffer size field, or both, identifies a total amount of data available according to a data volume calculation procedure across logical channels of a logical channel group after a medium access control packet data unit has been built.

In one embodiment, the indication is a radio resource control indication.

In one embodiment, the indication is a medium access control-control element indication or a downlink control information indication and wherein the indication is applicable for certain time duration or until a timer expires.

In one embodiment, the first table comprises 5-bit buffer size levels and the second table comprises 8-bit buffer size levels.

In one embodiment, the indication further comprises a logical channel group identifier, the indication indicating whether the short format BSR with the fixed size can be used for the logical channel group identifier.

In one embodiment, the indication indicates that the short format BSR with the fixed size can be used for a first logical channel group identifier and that the short format BSR with the fixed size cannot be used for a second logical channel group identifier.

In one embodiment, the first method determines a first logical channel identifier that corresponds to a BSR with the short format associated with the first logical channel group identifier and a second logical channel identifier that corresponds to a BSR with a long format associated with the second logical channel group identifier and prepare at least one of the BSR with the short format and the BSR with the long format.

In one embodiment, the first method determines whether a BSR is triggered, determine logical channel groups to be included in the BSR, determine a BSR format for the triggered BSR according to the indication and the determined logical channel groups, and transmit the BSR according to the determined BSR format.

In one embodiment, at least one of the first table and the second table is indicated for a logical channel in a corresponding logical channel configuration.

In one embodiment, logical channels of a logical channel group at least have the same first table, the same second table, or both.

In one embodiment, the first method reports a long format BSR based on the second table for logical channel groups that have data available for transmission in response to more than one logical channel group having data available for transmission when the medium access control packet data unit containing the BSR is built.

A second apparatus is disclosed for buffer status reporting for extended reality service. The second apparatus may include a network apparatus as described herein, for example, the gNB, base station 121, and/or the network equipment apparatus 800. In some embodiments, the second apparatus may include a processor executing program code, for example, a microcontroller, a microprocessor, a CPU, a GPU, an auxiliary processing unit, a FPGA, or the like.

In one embodiment, the second apparatus includes a transceiver and a processor coupled to the transceiver. In one embodiment, the processor is configured to cause the apparatus to transmit an indication to a UE that indicates a BSR format to be used for a BSR, the BSR format comprising one of a long format and a short format with a fixed size and receive a BSR according to the indicated BSR format, wherein in response to the indication indicating that a short format BSR with a fixed size can be used, determine a buffer size based on a first table that comprises buffer size levels corresponding to a first buffer size field, and wherein in response to the indication indicating that a short format BSR with a fixed size cannot be used, determine the buffer size based on a second table that comprises buffer size levels corresponding to a second buffer size field, the first buffer size field being shorter than the second buffer size field.

A second method is disclosed for buffer status reporting for extended reality service. The second method may be performed by a network apparatus as described herein, for example, the gNB, base station 121, and/or the network equipment apparatus 800. In some embodiments, the second method may be performed by a processor executing program code, for example, a microcontroller, a microprocessor, a CPU, a GPU, an auxiliary processing unit, a FPGA, or the like.

In one embodiment, the second method transmits an indication to a UE that indicates a BSR format to be used for a BSR, the BSR format comprising one of a long format and a short format with a fixed size and receive a BSR according to the indicated BSR format, wherein in response to the indication indicating that a short format BSR with a fixed size can be used, the second method determines a buffer size based on a first table that comprises buffer size levels corresponding to a first buffer size field, and wherein in response to the indication indicating that a short format BSR with a fixed size cannot be used, the second method determines the buffer size based on a second table that comprises buffer size levels corresponding to a second buffer size field, the first buffer size field being shorter than the second buffer size field.

Embodiments may be practiced in other specific forms. The described 5 embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An user equipment (UE) for wireless communication, comprising:
at least one memory; and
at least one processor coupled with the at least one memory and configured to cause the UE to:
receive an indication of whether a first buffer status report (“BSR”) format is usable;
in response to the indication indicating that the first BSR format is usable, determine a buffer size based on a first table that comprises buffer size levels corresponding to a first buffer size field;
in response to the indication indicating that the first BSR format is not usable, determine the buffer size based on a second table that comprises buffer size levels corresponding to a second buffer size field, the first buffer size field being shorter than the second buffer size field; and
transmit a BSR based on the buffer size.

2. The UE of claim 1, wherein the first buffer size field, the second buffer size field, or both, identifies a total amount of data available according to a data volume calculation procedure across logical channels of a logical channel group after a medium access control packet data unit has been created.

3. The UE of claim 1, wherein the indication is a radio resource control indication.

4. The UE of claim 1, wherein the indication is a medium access control-control element indication or a downlink control information indication and wherein the indication is applicable for a certain time duration or until a timer expires.

5. The UE of claim 1, wherein the first table comprises 5-bit buffer size levels and the second table comprises 8-bit buffer size levels.

6. The UE of claim 1, wherein the indication further comprises a logical channel group identifier, the indication indicating whether the first BSR format is usable for the logical channel group identifier.

7. The UE of claim 6, wherein the indication indicates that the first BSR format is usable for a first logical channel group identifier and that the first BSR format is not usable for a second logical channel group identifier.

8. The UE of claim 7, wherein the at least one processor is configured to cause the UE to determine a first logical channel identifier that corresponds to the BSR with the first BSR format associated with the first logical channel group identifier and a second logical channel identifier that corresponds to a second BSR format associated with the second logical channel group identifier and prepare at least one of the BSR with the first BSR format and the BSR with the second BSR format.

9. The UE of claim 1, wherein the at least one processor is configured to cause the UE to:
determine whether the BSR is triggered;
determine logical channel groups to be included in the BSR;
determine a BSR format for the triggered BSR according to the indication and the determined logical channel groups; and
transmit the BSR according to the determined BSR format.

10. The UE of claim 1, wherein the first table or the second table is indicated for a logical channel in a corresponding logical channel configuration.

11. The UE of claim 1, wherein logical channels of a logical channel group are associated with the first table, the second table, or both.

12. The UE of claim 1, wherein the at least one processor is configured to cause the UE to report a second BSR format based on the second table for logical channel groups that have data available for transmission in response to more than one logical channel group having data available for transmission when a medium access control packet data unit containing the BSR is created.

13. A method, comprising:
receiving an indication of whether a first buffer status report (“BSR”) format is usable;
in response to the indication indicating that the first BSR format is usable, determining a buffer size based on a first table that comprises buffer size levels corresponding to a first buffer size field;
in response to the indication indicating that the first BSR format is not usable, determining the buffer size based on a second table that comprises buffer size levels corresponding to a second buffer size field, the first buffer size field being shorter than the second buffer size field; and
transmitting a BSR based on the buffer size.

14. The method of claim 13, wherein the first buffer size field, the second buffer size field, or both, identifies a total amount of data available according to a data volume calculation procedure across logical channels of a logical channel group after a medium access control packet data unit has been created.

15. A network equipment (NE) for wireless communication, comprising:
at least one memory; and
at least one processor coupled with the at least one memory and; configured to cause the NE to:
transmit an indication of a buffer status report (“BSR”) format to be used for a BSR; and
receive a BSR according to the BSR format, wherein:
in response to the indication indicating that a first BSR format is usable, determine a buffer size based on a first table that comprises buffer size levels corresponding to a first buffer size field; and
in response to the indication indicating that the first BSR format is not usable, determine the buffer size based on a second table that comprises buffer size levels corresponding to a second buffer size field, the first buffer size field being shorter than the second buffer size field.

16. A processor for wireless communication, comprising:
at least one controller coupled with at least one memory and configured to cause the processor to:
receive an indication of whether a first buffer status report (“BSR”) format is usable;
in response to the indication indicating that the first BSR format is usable, determine a buffer size based on a first table that comprises buffer size levels corresponding to a first buffer size field;
in response to the indication indicating that the first BSR format is not usable, determine the buffer size based on a second table that comprises buffer size levels corresponding to a second buffer size field, the first buffer size field being shorter than the second buffer size field; and
transmit a BSR based on the buffer size.

17. The processor of claim 16, wherein the first buffer size field, the second buffer size field, or both, identifies a total amount of data available according to a data volume calculation procedure across logical channels of a logical channel group after a medium access control packet data unit has been created.

18. The processor of claim 16, wherein the indication is a radio resource control indication.

19. The processor of claim 16, wherein the indication is a medium access control-control element indication or a downlink control information indication and wherein the indication is applicable for a certain time duration or until a timer expires.

20. The processor of claim 19, wherein the first table comprises 5-bit buffer size levels and the second table comprises 8-bit buffer size levels.
